(19) United States
(12) Patent Application Publication
(10) Pub. No.: US 2011/0037390 A1
(43) Pub. Date: Feb. 17, 2011

(54) Multi-chip package LED lighting device

(76) Inventors: Young Kook Ko, Daegu-Si (KR); Sang Hee Park, Seoul (KR)

Correspondence Address: PAK, Chulmin, 15725 Weston Rd., Kettleby, ON, L0G 1J0, CA

(21) Appl. No.: 12/805,419

(22) Filed: Jul. 30, 2010

(30) Foreign Application Priority Data
Jul. 30, 2009 (KR) 10-2009-0069947

(51) Int. Cl. H01J 61/52

(52) U.S. Cl. 315/117

(57) ABSTRACT

A lighting device for providing mixtures of color temperature and intensity of light. The device comprises a case that contains: a multi-chip of light emitting diode (LED) to output mixtures of color temperature and intensity of light, having a plurality of blocks of LEDs each having a predetermined color temperature, the multi-chip LED being mounted on a printed circuit board (PCB); a cooling system attached on the back of the metal PCB, the cooling system using a fluid coolant for radiating heat generated by the multi-chip LED; and a control system electrically connected with the PCB of each block and the cooling system, the control system is adapted to supply power to the multi-chip LED, select the blocks of LEDs to be adjusted, adjust the color temperature and intensity of light of the selected block of LEDs to obtain mixtures of color temperatures and intensity of light.

### CROSS REFERENCE TO RELATED APPLICATION

### Priority Statement Under 35 U.S.C. S.119(e) & 37 C.F.R. S.1.78

This non-provisional patent application claims priority based upon the prior KOREAN patent application entitled “MULTI CHIP PACKAGING”, application Ser. No. 10-2009-0069947, filed Jul. 30, 2009, in the names of GO, YOUNG GUK, et al.

### BACKGROUND

1. Field

The present application relates to multi-chip light emitting devices.

2. Description of the Related Art

In general, halogen lights and flashtubes are commonly used in the studio of broadcasting or photography companies to obtain the desired light effect. These light sources require high electric power consumption in the range of 200 watts to two (2) kilowatts. Their life expectancy is relatively short, approximately 2 000 to 9 000 hours when fully used.

The strong heat levels generated from conventional light sources may often be harmful to the skin of persons exposed to generated light during a shoot. Heat build up from extended usage or poor heat dissipating systems also cause long term damage to the lighting equipment. In order to address these problems several relatively energy effective florescent light systems were introduced into the market but were not enough powerful to reach 20 000 lumens, which is often required in broadcasting.

Lately, energy efficient light emitting diodes (LEDs) were developed for broadcasting purposes. As they required only half of the energy used in conventional lighting devices and they provide up to 10 times more lifespan than conventional light sources. However, one (1) watt to three (3) watts LED light sources, generally used for street light and security lights had to be grouped to output up to 100-200 watts. However, this causes that too many LEDs are being used or that the size and weight of lighting devices would become too large and heavy.

Color temperature is a way of describing the colour of an incandescent light source. The power distribution in its spectrum is related to its absolute temperature in Kelvins (K), where 0K equals −273.15° C. For example, a halogen lamp has a color temperature of 3400K and unobscured midday sunlight is around 5500K. Some sources such as flashtubes, and fluorescent lamps that resemble incandescent sources, are given a correlated colour temperature. Color filters are usually balanced for daylight at 5500K, but professional films are available balanced for tungsten illumination at 3400K. Color temperature is one of the important requirements to the photography and broadcast industries. These industries require various color temperatures in order to obtain the special effects desired. Currently in several situations various color filters and accessories have to be incorporated into the lighting setup. While the result may be good, color filters serve to reduce light output and to reduce the intensity of radiation from the light source requiring greater outputs and more energy consumption.

### SUMMARY

It is a broad aspect of an embodiment to provide a lighting device for providing mixtures of color temperature and intensity of light, the device comprising: a case containing: a multi-chip of light emitting diode (LED) to output mixtures of color temperature and intensity of light, having a plurality of blocks of LEDs each having a predetermined color temperature, the multi-chip LED being mounted on a printed circuit board (PCB); a cooling system attached on the back of the PCB, the cooling system using a fluid coolant for radiating heat generated by the multi-chip LED; and a control system electrically connected with the PCB of each block and the cooling system, the control system being adapted to supply power to the multi-chip LED, select the blocks of LEDs to be adjusted, adjust the color temperature and intensity of light of the selected block of LEDs to obtain mixtures of color temperatures and intensity of light and provide control functions to the cooling system.

It is another broad aspect of an embodiment to provide a lighting device for providing mixtures of color temperature and intensity of light, the device comprising: a case containing: a multi-chip of light emitting diode (LED) to output mixtures of color temperature and intensity of light, having a plurality of blocks of LEDs each having a predetermined color temperature, the multi-chip LED being mounted on a metal substrate of a printed circuit board (PCB); a cooling system comprising a heat sink attached to the back of the PCB, the heat sink being connected to a cooling coil for cooling a coolant fluid, a spray jacket defining a chamber, the chamber having a plurality of nozzles facing the heat sink and inlet and outlet holes to be connected to the cooling coil, and a pump being adapted to circulate a coolant fluid in the cooling coil and to spray the coolant fluid on the back of the multi-chip LED to cool the multi-chip LED; and a control system electrically connected with the PCB of each block and the cooling system, the control system being adapted to supply power to the multi-chip LED, the control system having a control board having switches to control the multi-chip LED using channels, select the blocks of LEDs to be adjusted, adjust color temperature and intensity of light of the selected block of LEDs to obtain mixtures of color temperatures and intensity of light and provide control functions to the cooling system.

### BRIEF DESCRIPTION OF THE DRAWINGS

FIG. 1 is a front view of the lighting device;

FIG. 2 is a rear view of the lighting device;

FIG. 3 is a cross-sectional view of blocks of the multi-chip LED;

FIG. 4 is a cross-sectional view of the lighting device;

FIG. 5 is a cross-sectional view of a spray jacket of the lighting device; and

FIG. 6 is a functional diagram of the cooling system.

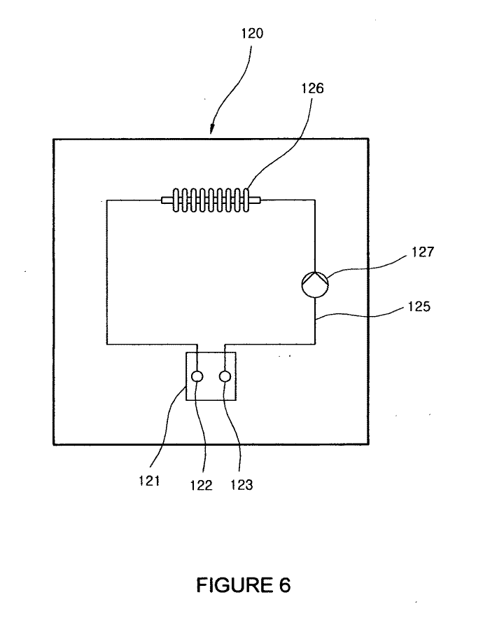

### DETAILED DESCRIPTION

In the following description, for purposes of explanation and not limitation, specific details are set forth such as particular architectures or techniques. It will be apparent to those skilled in the art that the lighting device may be practiced in other embodiments that depart from these specific details.

The lighting device light source is designed, for example, for the photography and broadcasting industries. This design enables the users to precisely control light intensity and color temperatures. Equipment costs, down time, power consumption may all be reduced by the use of multi-chip LED effectively to achieve higher degree of light efficiency and increase the portability.

The lightning device provides several facets of light sources not currently found in today's market like lower power consumption, longevity of bulb life, reduced heat generation, reduced overall size and weight while allowing for the customization of color temperature. The lighting device provides control of light intensity and color temperature using only one block or group of selected blocks. The lighting device increases light volume by reducing heat by spraying coolant fluid on the backside of LED blocks. The device is designed to be compact and light weight for the industries, for example, of broadcast and photography. In addition to the foregoing attributes, the multi-chip LED possesses numerous other benefits including; greatly reduced energy consumption as compared to today's technologies like halogen light source, increased portability because the lighting device is smaller and lighter. The device then provides instrumental in image capture while maintaining both adjustable high light volume output and color temperature consistency.

The lighting device comprises on the front side of a radiate plate on its front side, a plurality of blocks of LEDs, which are evenly spaced. Each block may comprise, for example, between seven (7) to nine (9) LEDs. Each block can be arranged in rows to create a light source of several possible shapes. Each row of blocks uses an applied coated florescent material with 3300K, 4600K or 5600K color temperature. Each block is independent from each adjacent block. Each row of blocks of LEDs is connected with three channels to control various color temperatures and light intensity for each block. This lighting device is assembled with multi-chip LED technology which controls the function of each row of LED blocks. When the lighting device is used in the context of broadcast and photography industries, it can be referred to as a LED studio light or a multi-chip package device.

LED light sources are subject to heat constraints that can negatively affect performance of the lighting device. The broadcast and photography industries, for example, require extremely sensitive color temperature and light volume adjustments to create pleasing exposures while introducing as little heat as possible into the working environment. In order to dissipate the heat, the lighting device comprises a jacket containing a cooling system which is attached to the back of each block and to a printed circuit board. The cooling system provides a fluid spray jacket with injection nozzles which is attached on the back side of the multi-chip LED and injects coolant fluid such as liquid or air onto the back of each row of blocks of LEDs. The spray jacket comprises a cooling coil and a fluid circulation pump. The coil passes through a condenser which cools the coolant fluid. The coolant fluid circulates through the coil and into the condenser where the heat is dissipated into the environment. This cools the fluid running along the cooling pipe and circulating back to the impingement jacket.

A control system, which acts as a master control box of the lighting device, is located on the rear side of the lighting device. The control system supplies electricity to the blocks of LEDs and the cooling system. The control system provides appropriate control of color temperature and light intensity, so that power can be directed by the device to specific areas of the multi-chip LED in order to create the desired lighting effect.

The lighting device uses a multi-chip LED to select color temperature as well as brightness and this feature enables users to create versatile scenes with one light source in a relatively short period. Furthermore, energy efficiency can be increased by cutting down heat loss with the built-in impingement cooling system.

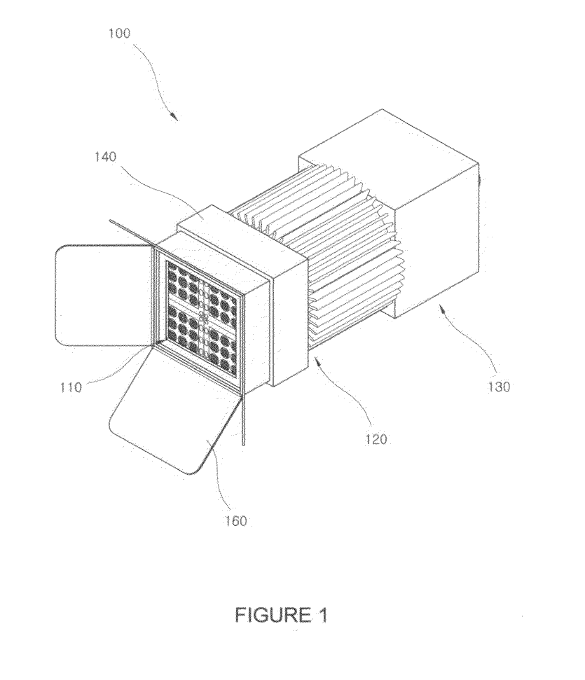

The device is now described with reference to the drawings. Reference is now made to FIG. 1, which is a front view of the lighting device 100. The lighting device 100 comprises a case 140 that contains a multi-chip LED 110, a cooling system 120 which prevents over heating the multi-chip LED 110 and a control system 130, which supplies power and provides control functions to the multi-chip LED 110 and the cooling system 120.

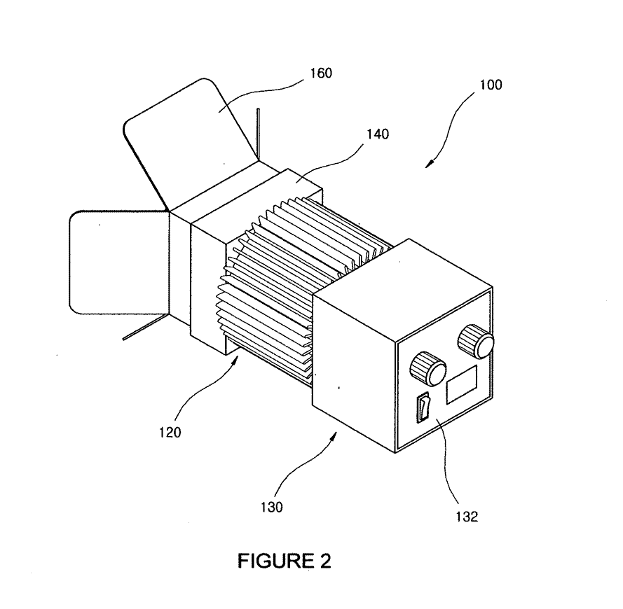

FIG. 2 illustrates a rear view of the lighting device which comprises a control board 132 of the control system 130. The control board comprises user controls such as on/off and up/down volume switches to control light intensity and color temperatures.

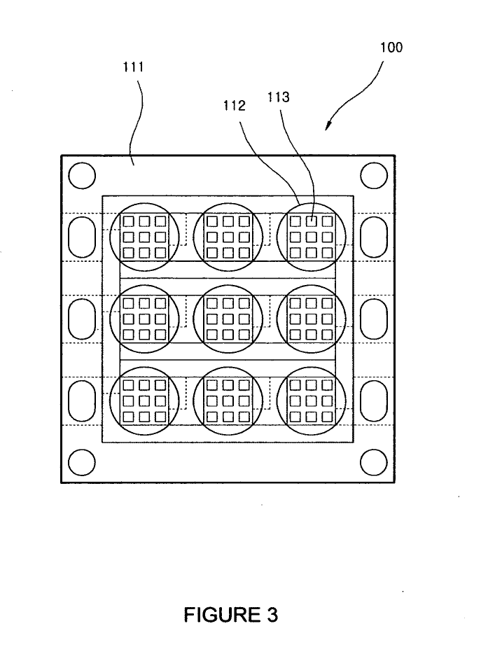

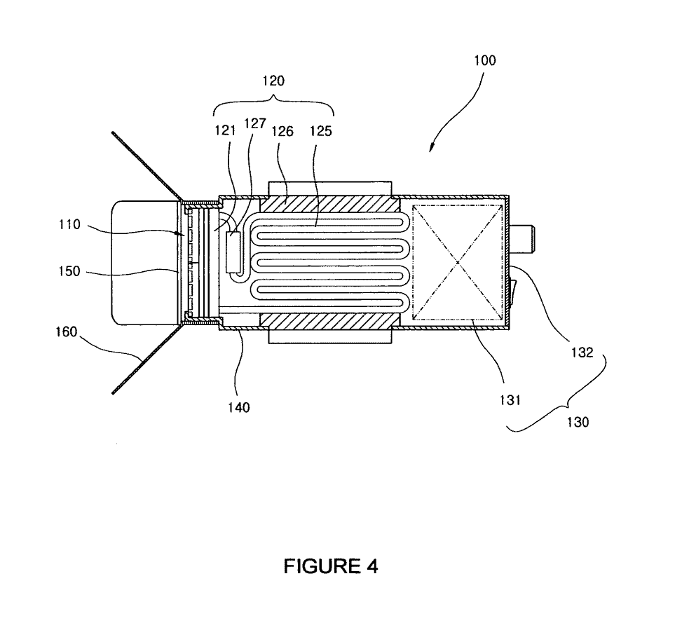

FIG. 3 shows a cross-sectional view of blocks 112 of LEDs 113. A multi-chip LED 110 is a source of light with a plurality of blocks 112 of LEDs 113. Each LED 113 can be about 45 millimeters (mm) and can require between one to three (3) watts to be powered up. The LEDs 113 are evenly spaced on the basic cell which is safely placed on each block. The multi-chip LED 110 can also be equipped with Electro-Static Discharge (EDS) circuits as safety device to prevent reverse or abnormal voltages and zener-diode to protect the unit from reverse voltage for further safety. As shown in FIG. 3, the LEDs 113 form a cell attached on a block 112 in order to maintain even light efficiency. A space of three (3) mm can be provided between the blocks 112. The LEDs 113 are safely attached on each block either in the shape of a circle or a rectangle. Each row, comprises three blocks 112 and may be combined and coated on separately with different color temperature florescent materials such as 3300K, 4600K and 5600K. It is therefore possible to obtain different color temperatures by controlling each channel of each row separately. FIG. 3 shows nine (9) evenly spaced blocks of multi-chip LED blocks 112 in three (3) rows, formed on the front of a printed circuit board (PCB) 111. The PCB 111 is used between blocks 112 and can be made and bonded with copper, aluminum or a any other substrate or bonding material that can provide heat control and high thermal conductivity during use of the lighting device. Bonding copper or aluminum can also make the entire PCB 111 section larger and provides heat control. The outside surface of the joined PCB 111 can be coated with chrome to prevent deformation by the heat of the spray jacket 121 (see FIG. 4 and the following description) which can be in copper material.

The PCB 111 radiates the heat obtained from LEDs 113 while light is being generated by the device 100. Each block 112 on the PCB 111 is formed with borders to prevent crossovers of color temperatures. The inner reflector of LED increases the efficiency of light transmission and the PCB 111 is designed in such a way to prevent heat generated by each LED 113 to be transferred to an adjacent block 112.

When a plurality of LEDs are connected to output light, there is a tendency that the central part of LEDs 113 are less efficient because of heat generated by lighting. LEDs 113 in a block 112 may be connected with wire over one (1) μm or bonded with thin strand of gold wire together to minimize junction temperature and to provide easier connections in a limited space.

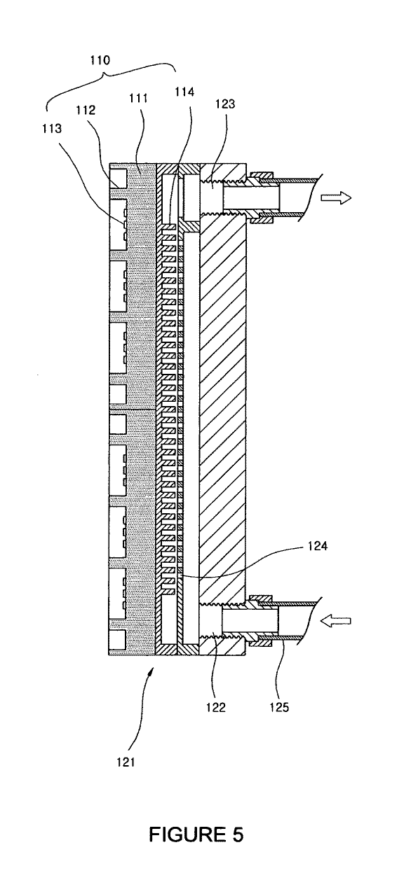

The cooling system 120 comprises two main parts. One is the spray-jacket 121 attached on the back of multi-chip LED 110 and the other is coil 125, which supplies coolant fluid to the spray-jacket 121. Reference is made to FIG. 5, which shows a heat sink 114 attached on the back of the spray jacket 121. The heat sink 114 is attached on the back of the PCB 111 in order to radiate the heat generated from LEDs 113. Coolant Fluid is sprayed on the heat sink 114 through the nozzles 124. Liquid coolant flows into the nozzle chamber through intake hole 122 which is connected to a cooling coil and it then flows out to the return side of the coil 125 through outlet hole 123 which is bored parallel along with the inlet hole 122.

In other words, the lightning device 100 is able to radiate away the accumulated heat by injecting coolant on the back of PCB 111. The coolant flows from the coil into the spray jacket 121 through inlet hole 122 to spray onto the heat sink 114 through the manifold nozzles 124 and flows back to the coil 125 through outlet hole 123.

The spray jacket 121 can be attached on the back of PCB 111 in one piece. This method of cooling the LEDs evenly differs from known cooling methods in lighting systems. A temperature unbalance like 0.1 to 0.5 degree in centigrade, can negatively affects the light considerably.

As shown in FIG. 4 and FIG. 5, the cooling coil 125 connected on the inlet 122 and outlet 123 holes passes through a condenser 126 where the coolant fluid is cooled. The coil connected to a micro pump 127 assists with the circulation of coolant. Water or air can be used as coolant fluid but any liquid or fluid with a low freezing point can be used to cool the multi-chip LEDs. Air cooling of condenser fins with fans can be used when the outside air temperature is lower than the temperature of LEDs.

Since each row of blocks 112 emits light independently, the lighted blocks must be cooled independently using spray jacket 121 to improve the cooling effect further. This partial cooling method focuses the spray injection onto the portion of the PCB 111 where the blocks are lighted by using up/down switches. Therefore, electronic valves such as piezoelectric elements or other types of small fluid control valves may be used to selectively direct coolant fluid to specific groups of nozzles 124 to spray coolant fluid onto appropriate portions of the heat sink 114 to cool corresponding portions of the PCB 111.

FIG. 1, FIG. 2 and FIG. 4 show the power system 130 which supplies power to the cooling system 120 and to the multi-chip LED 110 and controls the functions. As shown in FIGS. 1, 2 and 4, the power supply section 131 receives external power and supplies it to the multi-chip LED 110, the cooling system 120 and a control board 132 which is connected on the outside. The control board 132 controls the operations of LEDs 113, the selection of each block 112 and the fine adjustment of the brightness of LEDs

The lighting device 100 can be designed in the shape of ordinary lighting system. The outside case 140 of the lighting device 100 is anodized with aluminum to further augment the radiation of heat. It contains all three major parts, multi-chip LED 110, cooling system 120 and control system 130. A silicon lens 150 is placed in front of the LEDs 113 for light diffusion or concentration as well as for the protection of the multi-chip LEDs 113 from physical damage. Panels or reflectors 160 may also be used to direct the outputted light at a desired angle or to generate a spot light towards a desired location.

### Operation of the Lighting Device

To operate the lighting device 100 and to set up a desired color temperature and brightness, the device 100 uses a switch on the control board and selectively illuminate LEDs on the row of blocks 112. The control board may allow a user to select three different default modes of color temperatures such as 3300K, 4600K and 5600K. An up/down volume switch in combination with the color temperature switches creates the desired color temperature in addition to the three default different color temperatures. Thus, the lighting device 100 may readily create any desired combination of color temperature and intensity of light, which enables users to diversify the performance and produce enough intensity of light for broadcasting and photography in both a studio or any determined environment. A skilled person would understand that the device may generate hundreds of different color temperatures and brightness patterns using the switches on the control board.

The front surface of the multi-chip LED 110 is for the emission of light by LEDs 113 in blocks 112 to obtain higher volume of light in a compact surface. The front surface can be a flat surface. As this concentrated light emission generates heat, the device 100 comprises a cooling system 120 to protect the LEDs and the device 100. The back side of multi-chip LED 110 is attached to the PCB 111 and the PCB 111 is attached to the heat sink 114, which transmits heat to the cooling system 120. Heat is transferred to the cooling system 120 via the coiled pipe 125 with a spraying action from the back of heated blocks 112 through the nozzles 124 of the spray jacket 121. A coolant fluid passes through the condenser 126 to cool off the temperature of the multi-chip LED 113 and is forced to flow back into the spray jacket 121 by the micro pump 127.

Cooling the heat sink effectively by spraying coolant fluid through the nozzles increases the efficiency of cooling effect by selecting the luminous LED blocks for desired color temperature and thus improves the efficiency of outputted light volume and the quality and stability of output light.

In conclusion, the practical application of the device is not to be limited to those examples described above or the drawings shown. Although several preferred embodiments of the device has been described and illustrated in the accompanying Drawings and described in the foregoing Detailed Description, it will be understood that the invention is not limited to the embodiments disclosed, but is capable of numerous rearrangements, modifications and substitutions, without departing from the scope of the claims.

### BRIEF DESCRIPTION OF NUMERALS IN THE DRAWINGS AS BELOW

100: Lighting device

110: Multi-chip LED

111: Printed circuit board (PCB)

112: LED block

113: LED

114: Heat sink (Radiant plate)

120: Cooling system

121: Spray Jacket

122: Inlet hole

123: Outlet hole

124: Spray nozzle

125: Cooling coil

126: Condenser

127: Micro pump

130: Control system

131: Power supply module

132: Control board

140: Case

150: Silicon lens

160: Reflectors

What is claimed is:

1. A lighting device for providing mixtures of color temperature and intensity of light, the device comprising:
a case containing:
a multi-chip of light emitting diode (LED) to output mixtures of color temperature and intensity of light, having a plurality of blocks of LEDs each having a predetermined color temperature, the multi-chip LED being mounted on a printed circuit board (PCB);
a cooling system attached on the back of the PCB, the cooling system using coolant fluid for radiating heat generated by the multi-chip LED; and
a control system electrically connected with the PCB of each block and the cooling system, the control system being adapted to supply power to the multi-chip LED, select the blocks of LEDs to be adjusted, adjust the color temperature and intensity of light of the selected block of LEDs to obtain mixtures of color temperatures and intensity of light and provide control functions to the cooling system.

2. The lighting device of claim 1, wherein the plurality of blocks of LEDs form rows according to a predetermined color temperature.

3. The lighting device of claim 2, wherein the blocks of LEDs are coated with a different fluorescent material on each row in order to have different color temperatures and for each block of LEDs, each row being bonded along and connected to a control board of the control system to output mixture of color temperature and intensity of light through from the selected blocks of LEDs.

4. The lighting device of claim 3, wherein each LED of the multi-chip LED are connected with thin strands of gold wire and the blocks of a same color temperature are connected with one of copper and aluminum to provide heat control.

5. The lighting device of claim 1, wherein the PCB comprises a metal substrate to provide heat control.

6. The lighting device of claim 1, wherein the cooling system comprises a heat sink attached to the back of the PCB.

7. The lighting device of claim 1, wherein the cooling system further comprises a spray jacket defining a chamber having a plurality of nozzles facing the heat sink.

8. The lighting device of claim 7, wherein the cooling system further comprises a cooling coil being connected to the chamber through inlet and outlet holes.

9. The lighting device of claim 8, wherein the cooling system comprises a condenser surrounding the cooling coil which is connected to a micro pump to circulate in the cooling coil a coolant liquid to be sprayed on the back of the multi-chip LED to cool the multi-chip LED.

10. The lightning device of claim 6 wherein the cooling system works selectively only on the portion of the heat sink where the multi-chip LED is radiated with an electronic valve, the cooling system increasing cooling effect by cooling only the needed portions of the multi-chip LED.

11. The lighting device of claim 6, wherein the cooling system further comprises a means for spraying the coolant fluid on the back of the heat sink mounted on the back of the PCB and a spray jacket attached on the back of the heat sink and connected to the cooling coil to cool the coolant fluid.

12. The lighting device of claim 9, wherein the condenser is an air cooling system using a fan and outside air to cool coolant fluid in the cooling coil.

13. The lighting device of claim 1, wherein the control system comprises a power supply box to provide power to the multi-chip LED and the cooling system.

14. The lighting device of claim 1, wherein the control system comprises a control board having switches to control the multi-chip LED using channels to adjust color temperatures.

15. A lighting device for providing mixtures of color temperature and intensity of light, the device comprising:
a case containing:
a multi-chip of light emitting diode (LED) to output mixtures of color temperature and intensity of light, having a plurality of blocks of LEDs each having a predetermined color temperature, the multi-chip LED being mounted on a metal substrate of a printed circuit board (PCB);
a cooling system comprising a heat sink attached to the back of the PCB, the heat sink being connected to a cooling coil for cooling a coolant fluid, a spray jacket defining a chamber, the chamber having a plurality of nozzles facing the heat sink and inlet and outlet holes to be connected to the cooling coil, and a pump being adapted to circulate a coolant fluid in the cooling coil and to spray the coolant fluid on the back of the multi-chip LED to cool the multi-chip LED; and
a control system electrically connected with the PCB of each block and the cooling system, the control system being adapted to supply power to the multi-chip LED, the control system having a control board having switches to control the multi-chip LED using channels, select the blocks of LEDs to be adjusted, adjust color temperature and intensity of light of the selected block of LEDs to obtain mixtures of color temperatures and intensity of light and provide control functions to the cooling system.
